(19) United States
(12) Patent Application Publication
(10) Pub. No.: US 2011/0031747 A1
(43) Pub. Date: Feb. 10, 2011

(54) VARIABLE LIQUID COLUMN OSCILLATOR USING WAVE ENERGY

(76) Inventors: Byung-hak CHO, Daejeon (KR); Dong-soon Yang, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/614,386

(22) Filed: Nov. 6, 2009

(30) Foreign Application Priority Data
Aug. 7, 2009 (KR) 10-2009-0072896

(51) Int. Cl. F03B 13/14

(52) U.S. Cl. 290/42

(57) ABSTRACT

Disclosed is a variable liquid column oscillator using wave energy in which an energy absorption mechanism of a wave energy apparatus tunes vibration characteristics responding to waves to a vibration cycle of waves to maximize energy absorption efficiency.

### BACKGROUND OF THE INVENTION

1. Field of the Invention

The present invention relates to a variable liquid column oscillator using wave energy which efficiently absorbs a large amount of energy from waves generated in the ocean by wind, and more particularly to a variable liquid column oscillator using wave energy in which an energy absorption mechanism of a wave energy apparatus tunes vibration characteristics responding to waves to a vibration cycle of waves to maximize energy absorption efficiency.

2. Description of the Related Art

As already known, movement on a water surface generated in the ocean by wind and another movement caused by the movement on the water surface when the movement on the water surface advances to another sea area in an attenuated state are called waves.

There are several kinds of wave energy generation using such waves. As an example, a buoy having a generator and a pendulum mounted therein floats in the water, such that the buoy is shaken by waves, to obtain movement of the pendulum, to convert the movement of the pendulum into rotational movement, and to rotate the generator through gears, thereby producing electric power. As another example, the upward and downward movement of waves is converted into electric power, thereby producing electric power.

However, each of the conventional movable object type wave energy apparatuses as described above does not have a function to tune the vibration of a system body to a cycle of waves. Specifically, each of the conventional movable object type wave energy apparatuses is mechanically tuned to improve energy conversion efficiency only in a specific condition of waves. As a result, the energy conversion efficiency in various conditions of waves in the ocean is merely approximately 10%, which is very low.

### SUMMARY OF THE INVENTION

Therefore, the present invention has been made in view of the above problems, and it is an object of the present invention to provide a variable liquid column oscillator using wave energy that is capable of improving energy conversion efficiency, which is merely approximately 10% in a conventional movable object type wave energy apparatus, to approximately 30%, thereby achieving commercial value.

In accordance with the present invention, the above and other objects can be accomplished by the provision of a variable liquid column oscillator using wave energy including a variable liquid column body having a U-shaped tube comprising a horizontal tube and vertical tubes communicating with each other through the horizontal tube, and air chambers connected to the vertical tubes, the air chambers being isolated from each other about an isolation plate, an air tube to connect the air chambers to each other, control valves mounted on the air tube, pressure transformers connected to the air chambers, respectively, and a level transformer connected to one of the vertical tubes, and a controller to which the control valves, the pressure transformers, and the level transformer are connected.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an overall construction view of a variable liquid column oscillator using wave energy according to the present invention;

FIG. 2(A) is an enlarged view of a variable liquid column body according to the present invention in a level state;

FIG. 2(B) is an enlarged view of the variable liquid column body according to the present invention in an inclined state in which the variable liquid column body is inclined at a predetermined angle;

FIG. 3 is a view illustrating variable liquid column oscillators according to the present invention installed at a sea surface in a state in which the variable liquid column oscillators are connected to one another via power take offs (PTO);

FIG. 4 is a graph illustrating an air spring constant of the present invention according to a first method;

FIG. 5 is a graph illustrating open loop frequency response characteristics of the variable liquid column body according to the present invention and a conventional movable object type wave energy apparatus;

FIG. 6 is a graph illustrating control frequency response characteristics of the present invention according to a first control method; and

FIG. 7 is a graph illustrating control frequency response characteristics of the present invention according to a second control method.

### DETAILED DESCRIPTION OF THE INVENTION

Now, a preferred embodiment of the present invention will be described in detail with reference to the accompanying drawings.

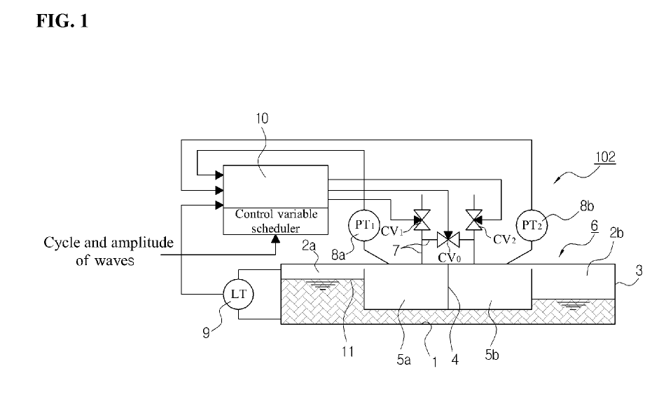

FIG. 1 is an overall construction view of a variable liquid column oscillator using wave energy according to the present invention.

A plurality of variable liquid column oscillators 102, one of which is shown in FIG. 1, are installed at a sea surface 100 in a state in which the variable liquid column oscillators 102 are connected to one another via power take offs (PTO) 101 which are hingedly connected to one another, as shown in FIG. 3. The variable liquid column oscillators 102 have the same structure. Therefore, one of the variable liquid column oscillators 102 will be described in detail hereinafter with reference to FIG. 1.

The variable liquid column oscillator 102 includes: a variable liquid column body 6 having a U-shaped tube 3 including a horizontal tube 1 and vertical tubes 2a and 2b communicating with each other through the horizontal tube 1, and air chambers 5a and 5b connected to the vertical tubes 2a and 2b, the air chambers 5a and 5b being isolated from each other about an isolation plate 4; an air tube 7 to connect the air chambers 5a and 5b to each other; three control valves CV₁, CV₀ and CV₂ mounted on the air tube 7; pressure transformers 8a and 8b connected to the air chambers 5a and 5b, respectively, and a level transformer 9 connected to the vertical tube 2a; and a controller 10 to which the control valves CV₁, CV₀ and CV₂, the pressure transformers 8a and 8b, and the level transformer 9 are connected.

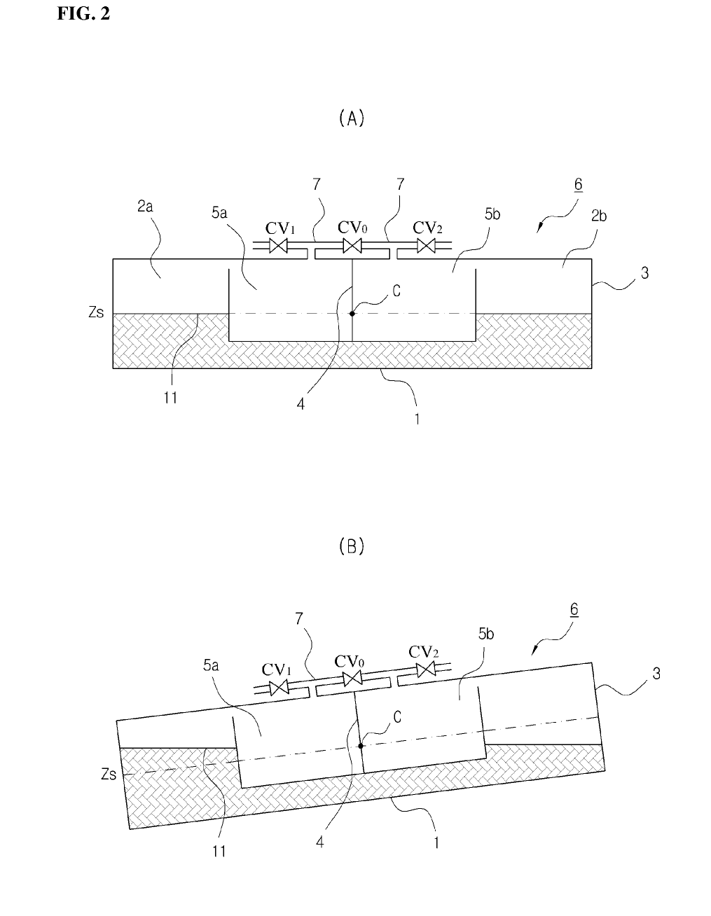

When the variable liquid column body 6 is at the sea surface 100 in a level state, i.e., in an equilibrium state, as shown in FIG. 2(A), the controller 10 controls air pressures Po of the air chambers 5a and 5b based on the amplitude and cycle of waves to improve energy absorption efficiency. On the other hand, when the variable liquid column body 6 is at the sea surface 100 in an inclined state, as shown in FIG. 2(B), the controller 10 controls the control valves CV₁, CV₀ and CV₂ disposed between the air chamber 5a and the air chamber 5b to be opened and closed at a specific reference level Zs of internal operating liquid 11 contained in the U-shaped tube 3 based on the amplitude and cycle of waves to improve energy absorption efficiency.

Also, when frozen waves are generated, the controller 10 controls air pressures Po of the air chambers 5a and 5b such that the variable liquid column oscillator 102 according to the present invention is operated in a tuned liquid column damper region to reduce excessive load applied from the frozen waves.

Meanwhile, a predetermined amount of the internal operating liquid 11 is contained in the U-shaped tube 3. Water or seawater may be used as the internal operating liquid.

Hereinafter, the operation of the variable liquid column oscillator according to the present invention will be described in detail.

A method of vibrating the variable liquid column oscillator according to the present invention such that the variable liquid column oscillator is tuned to the cycle of waves includes a first control method of controlling air pressures Po of the air chambers 5a and 5b in an equilibrium state using the center control valve CV₀ and the control valve CV₂ of the air chamber 5b and a second control method of nonlinearly controlling pressures of the air chambers 5a and 5b using the center control valve CV₀ in a state in which the control valves CV₁ and CV₂ of the air chambers 5a and 5b are closed.

Both of the control methods are used to induce spring effects caused by compression and expansion of air to control a natural vibration cycle of the variable liquid column oscillator according to the present invention.

First, a spring constant of an air spring according to the first control method is linearly proportional to air pressures Po of the air chambers 5a and 5b in an equilibrium state, on the assumption that an amount of air volume changed by the fluctuation in level of the internal operating liquid 11 is sufficiently small as compared with the volumes of the air chambers 5a and 5b.

When the air chambers 5a and 5b are under total vacuum, therefore, the spring constant is 0. With the increase in pressure of the air chambers 5a and 5b, the spring constant increases.

Meanwhile, the air pressures Po of the air chambers 5a and 5b may be controlled by the control valves CV₁ and CV₂ connected to the air chambers 5a and 5b, respectively, without the provision of additional compression or vacuum pumps.

For example, when pressures of the air chambers 5a and 5b exceed atmospheric pressure due to the internal operating liquid 11 of the variable liquid column body 6, the control valves CV₁ and CV₂ are opened to discharge a predetermined amount of air to the atmosphere, with the result that air pressures Po of the air chambers 5a and 5b are kept below atmospheric pressure. On the other hand, when pressures of the air chambers 5a and 5b are lower than atmospheric pressure, the control valves CV₁ and CV₂ are opened to suction air from the atmosphere, with the result that air pressures Po of the air chambers 5a and 5b are kept above atmospheric pressure.

In the second control method, the center control valve CV₀ is opened and closed only under a specific condition based on the level of the internal operating liquid 11 to achieve air spring effects.

In the second control method, when the level of the internal operating liquid 11 contained in the vertical tubes 2a and 2b is higher or lower than a predetermined specific reference level Zs, the center control valve CV₀ is rapidly closed to compress or expand air in the air chambers 5a and 5b by inertia force of the internal operating liquid 11, thereby achieving air spring effects.

For example, when all of the control valves CV₁, CV₀ and CV₂ are closed in a state in which the variable liquid column oscillator according to the present invention is inclined at a predetermined angle by waves of seawater, as shown in FIG. 2(B), the internal operating liquid 11 contained in the vertical tube 2a compresses the air in the air chamber 5a, whereas the internal operating liquid 11 contained in the vertical tube 2b expands the air in the air chamber 5b, thereby generating force to restore the level of the internal operating liquid 11 to a level before the center control valve CV₀ is closed.

In a region in which the level of the internal operating liquid 11 does not exceed a range of the predetermined specific reference level Zs, however, the center control valve CV₀ is opened, and therefore, no air spring effects are induced. As a result, the internal operating liquid 11 freely moves in the U-shaped tube 3 without restriction.

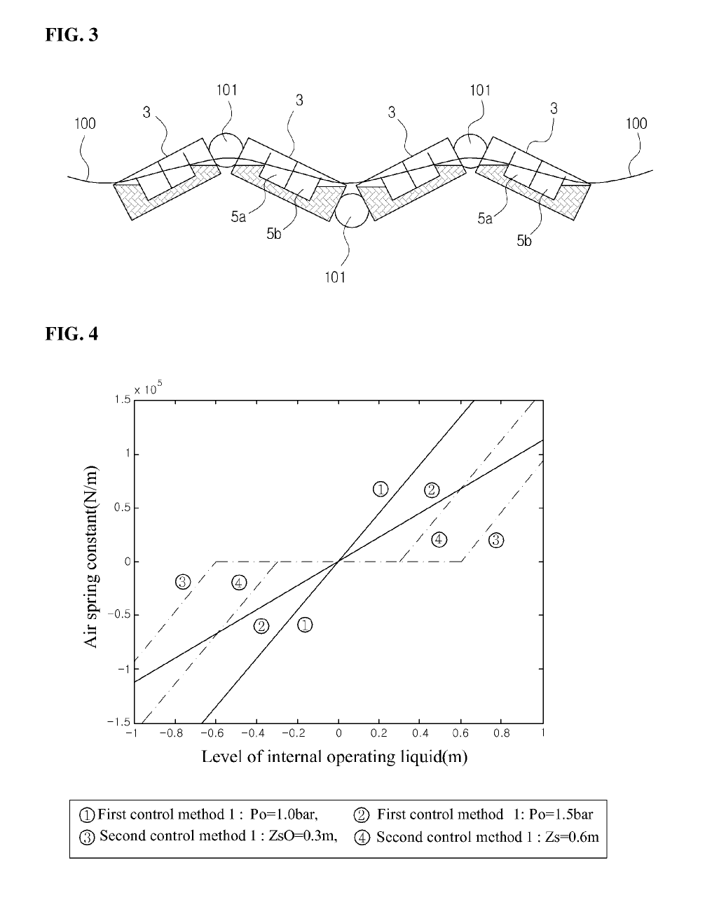

Examples of the air springs derived from the first and second control methods are shown in FIG. 4, which illustrates the relationship between the air spring constants and the level of the internal operating liquid.

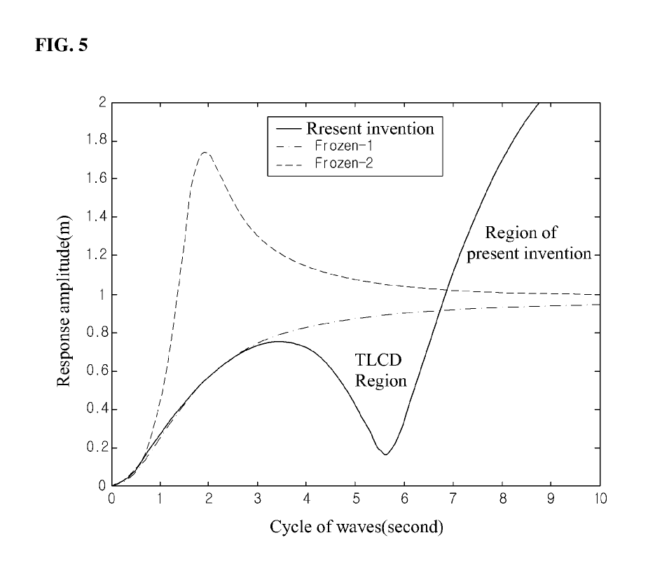

Meanwhile, FIG. 5 is a graph illustrating general open loop frequency response characteristics of the variable liquid column oscillator according to the present invention and a conventional movable object type wave energy apparatus.

In FIG. 5, a state of frozen waves (Frozen) means a state in which the movement of the internal operating liquid 11 is forcibly restricted.

In the graph of FIG. 5, responses of the present invention and Frozen-1 are results obtained by equalizing the coefficients of viscous friction for energy absorption.

The coefficient of viscous friction for energy absorption is generated by an electric generator installed at the rotation center C of the variable liquid column body, as shown in FIG. 2, to convert rotational energy into electric power.

It can be seen that, when a cycle of waves is between approximately 4 seconds and approximately 7 seconds, the response of the present invention is much less than the response of Frozen-1. The region in which the response of the present invention is much less than the response of Frozen-1 is a tuned liquid column damper (TLCD) region. However, it can be seen that, when a cycle of waves exceeds approximately 7 seconds, the response of the present invention is much greater than the response of Frozen-1. The region in which the response of the present invention is much greater than the response of Frozen-1 is a variable liquid column oscillation region.

A cycle of waves generally generated in the ocean is between approximately 4 seconds and approximately 9 seconds. On the other hand, the open loop frequency response of the present invention includes the TLCD region existing between approximately 4 seconds and approximately 7 seconds. Therefore, it is necessary to avoid the TLCD region.

To this end, it is necessary to perform control including the above-mentioned air spring effects. As a result, a resonance cycle of the TLCD region is reduced to less than 4 seconds, and therefore, the response in a region having an effective cycle of waves is greater than the response of Frozen-1 shown in the graph of FIG. 5.

Also, Frozen-2, shown in the graph of FIG. 5, is a response obtained when the coefficient of viscous friction for energy absorption is less than that of Frozen-1. It can be seen that a resonance cycle of the present invention is approximately 1.9 seconds in a state of frozen waves. On the other hand, a resonance cycle of the conventional apparatus is approximately 1.9 seconds in a state of frozen waves, which is considerably different from the effective cycle of waves, i.e., approximately 4 seconds to approximately 9 seconds. As a result, it is not possible to efficiently absorb energy.

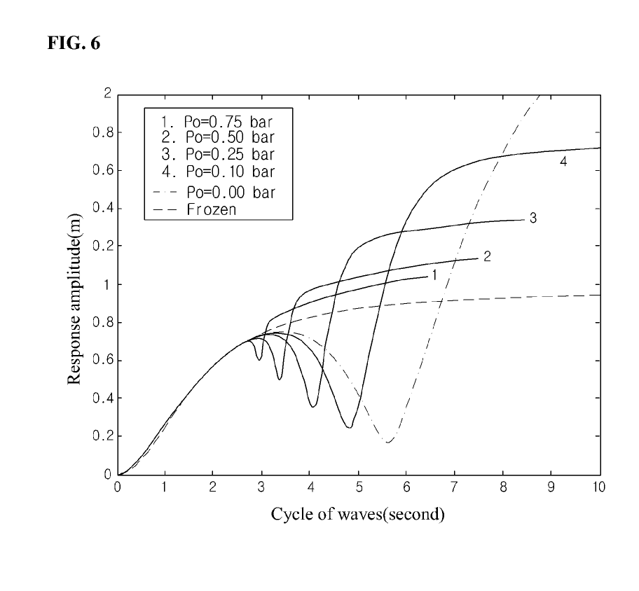

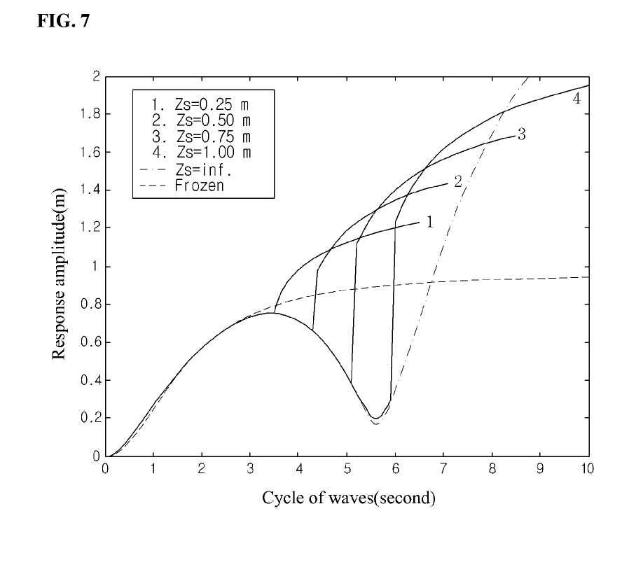

FIG. 6 is a graph illustrating control frequency response characteristics of the present invention according to the first control method.

The greater the air pressures Po of the air chambers 5a and 5b are increased in an equilibrium state, the shorter a cycle of waves in which the TLCD region is formed is. When the air pressures Po of the air chambers 5a and 5b are appropriately adjusted according to such a cycle of waves, the response of the present invention according to the first method is always greater than the response in a state of frozen waves.

FIG. 7 is a graph illustrating control frequency response characteristics of the present invention according to the second control method.

It can be seen that the TLCD region is not shifted as in the control frequency response characteristics of the present invention according to the first control method; however, the higher the predetermined specific reference level Zs of vertical tubes 2a and 2b is, the greater amplitude of the response is in a short cycle of waves.

When the predetermined specific reference level Zs is appropriately adjusted according to a cycle of waves, therefore, the response of the present invention according to the second control method is always greater than the response in a state of frozen waves.

In the first control method of the present invention, the air pressures Po of the air chambers 5a and 5b when the variable liquid column oscillator according to the present invention is in an equilibrium state as shown in FIG. 2(A) are defined as control variables. In the second control method of the present invention, on the other hand, the predetermined specific reference level Zs of the vertical tubes 2a and 2b, at which the center control valve CV₀ is opened or closed according to the level of the internal operating liquid 11 contained in the variable liquid column body 6, is defined as a control variable.

In addition to these control variables, the coefficient of viscous friction generated from the electric generator for energy absorption in a power operation serve as a variable greatly affecting the behavior of the variable liquid column oscillator according to the present invention.

In the power operation of the present invention, therefore, the air pressures Po of the air chambers 5a and 5b to absorb maximum energy in the amplitude and cycle of waves given according to the first and second control methods and the coefficient of viscous friction, or the predetermined specific reference level Zs and the coefficient of viscous friction, are calculated. Subsequently, these control variables are scheduled according to the amplitude and cycle of waves through the controller 10 according to the present invention, described with reference to FIG. 1.

Meanwhile, simulations of the control methods applied to the present invention reveal that, when the first control method is applied to the present invention, the present invention absorbs 1.5 to 2.6 times more energy than a conventional energy absorption type wave energy apparatus in a wave condition such as in the ocean, and, when the second control method is applied to the present invention, the present invention absorbs 1.9 to 2.2 times more energy than the conventional energy absorption type wave energy apparatus in the same wave conditions.

As apparent from the above description, it is possible for the variable liquid column oscillator using wave energy according to the present invention to oscillate while being tuned to a cycle of waves. Therefore, the present invention has the effect of more efficiently absorbing wave energy than a conventional wave energy apparatus, thereby improving commercial value.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A variable liquid column oscillator using wave energy comprising:
a variable liquid column body having a U-shaped tube comprising a horizontal tube and vertical tubes communicating with each other through the horizontal tube, and air chambers connected to the vertical tubes, the air chambers being isolated from each other about an isolation plate;
an air tube to connect the air chambers to each other;
control valves mounted on the air tube;
pressure transformers connected to the air chambers, respectively, and a level transformer connected to one of the vertical tubes; and
a controller to which the control valves, the pressure transformers, and the level transformer are connected.

2. The variable liquid column oscillator according to claim 1, wherein, when the variable liquid column body is in a level state, i.e., in an equilibrium state, the controller controls air pressures of the air chambers based on an amplitude and cycle of waves to improve energy absorption efficiency.

3. The variable liquid column oscillator according to claim 1, wherein the controller controls the control valves disposed between the air chambers to be opened and closed at a specific reference level of internal operating liquid based on an amplitude and cycle of waves to improve energy absorption efficiency.

4. The variable liquid column oscillator according to claim 1, wherein, when frozen waves are generated, the controller controls air pressures of the air chambers such that the variable liquid column oscillator is operated in a tuned liquid column damper region to reduce excessive load applied from the frozen waves.

5. The variable liquid column oscillator according to claim 1, wherein the U-shaped tube is filled with a predetermined amount of internal operating liquid, and water or seawater is used as the internal operating liquid.
